(19) United States
(12) Patent Application Publication
(10) Pub. No.: US 2010/0261829 A1
(43) Pub. Date: Oct. 14, 2010

(54) Material for Manufacturing Environment Friendly Outsoles

(76) Inventor: Kun-Chu Lin, Fengyuan City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/422,335

(22) Filed: Apr. 13, 2009

(51) Int. Cl. C08K 3/34

(52) U.S. Cl. 524/451

(57) ABSTRACT

A material for manufacturing environment friendly outsoles includes a composition of TPE being 35 wt % to 45 wt % of a single outsole; a composition of silica being 1 wt % to 10 wt % of the single outsole; a composition of talcum powder being 0.1 wt % to 1 wt % of the single outsole; a composition of white oil being 15 wt % to 40 wt % of the single outsole; a composition of PS being 1 wt % to 10 wt % of the single outsole; a composition of HDPE being 1 wt % to 10 wt % of the single outsole; a composition of rice chaff powder being 10 wt % to 30 wt % of the single outsole; and a composition of SEBS being 1 wt % to 10 wt % of the single outsole. Weight reduction and durability are main advantages of the outsoles.

### BACKGROUND OF THE INVENTION

1. Field of Invention

The invention relates to outsole materials and more particularly to a material for manufacturing environment friendly outsoles.

2. Description of Related Art

A conventional outsole is made from plastics or wood. Plastics are made from petrochemical materials which are considered to be not environment friendly because plastic products do not tend to degrade after being discarded. Moreover, petroleum resources are limited. Excessive consumption of petroleum resources not only pollutes environment but also drives fuel oil cost up greatly. For obtaining wood, cutting trees is inevitable and this is also considered to be not environment friendly.

How to protect environment is a global issue. The reduction of the consumption of precious resources (e.g., petroleum, wood, or the like) is very important for all people and all manufacturers throughout the world. Thus, it is desirable to provide a novel material for manufacturing environment friendly outsoles in order to eliminate the drawbacks of the conventional material for manufacturing outsoles.

### SUMMARY OF THE INVENTION

It is therefore one object of the invention to provide a material for manufacturing environment friendly outsoles in order to overcome the inadequacies of the conventional material for manufacturing an outsole (e.g., excessive consumption of petroleum or wood as being considered less environment friendly compared to biodegradable materials or reusable materials).

To achieve the above and other objects, the invention provides a material for manufacturing environment friendly outsoles comprising a first composition of TPE being 35 wt % (weight percentage) to 45 wt % of a single one of the outsoles; a second composition of silica being 1 wt % to 10 wt % of the single one of the outsoles; a third composition of talcum powder being 0.1 wt % to 1 wt % of the single one of the outsoles; a fourth composition of white oil being 15 wt % to 40 wt % of the single one of the outsoles; a fifth composition of PS being 1 wt % to 10 wt % of the single one of the outsoles, a sixth composition of HDPE being 1 wt % to 10 wt % of the single one of the outsoles; a seventh composition of rice chaff powder being 10 wt % to 30 wt % of the single one of the outsoles; and an eighth composition of SEBS being 1 wt % to 10 wt % of the single one of the outsoles.

In one aspect of the invention the first composition of TPE, the second composition of silica, the third composition of talcum powder, the fourth composition of white oil, the fifth composition of PS, the sixth composition of HDPE, and the eighth composition of SEBS are mixed in a mixer at a first temperature for a first period of time; the seventh composition of rice chaff powder is poured into the mixture for further mixing at a second temperature until the mixture is in a molten state; and the molten mixture is conveyed to an injection molding machine for producing the outsoles.

In another aspect of the invention the first temperature is about 100° C.

In still another aspect of the invention the first period of time is about 600 seconds.

In a further aspect of the invention the second temperature is between 150° C. to 160° C.

By utilizing the invention, a plurality of advantages are obtained and detailed below. The provision of the compositions of rice chaff powder and other non-plastic materials can not only reduce shoe weight but also reduce the consumption of petroleum and plastics (i.e., reducing carbon emission). Further, the produced outsoles are structurally strong and highly resistant to wear (i.e., durable). People treat rice chaff as waste. Hence, rice chaff is typically discarded or burned. This is not environment friendly because it may pollute environment. It is envisaged by the invention that rice chaff is pulverized to nanometer grade. Therefore, the produced outsoles are environment friendly.

The above and other objects, features and advantages of the invention will become apparent from the following detailed description taken with the accompanying drawings.

### BRIEF DESCRIPTION OF THE DRAWINGS

FIG. 1 is a perspective view of a preferred embodiment of environment friendly outsole according to the invention; and

FIG. 2 is a block diagram of compositions of a material for manufacturing the environment friendly outsole of FIG. 1.

### DETAILED DESCRIPTION OF THE INVENTION

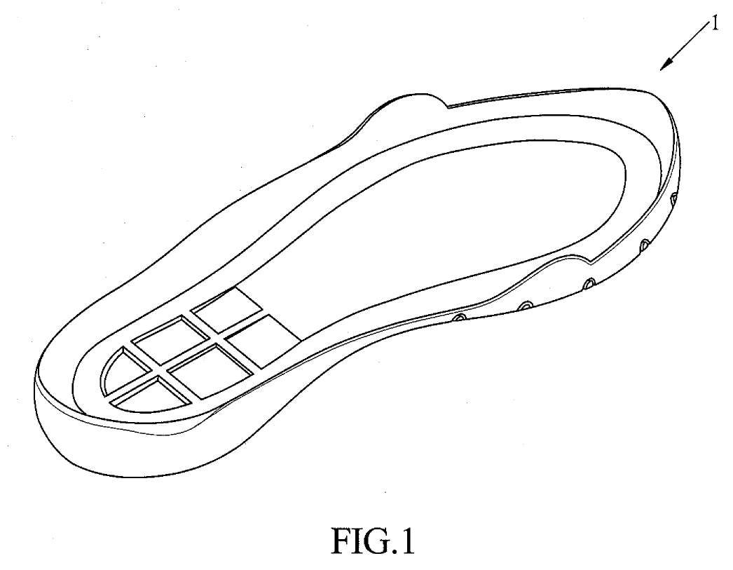

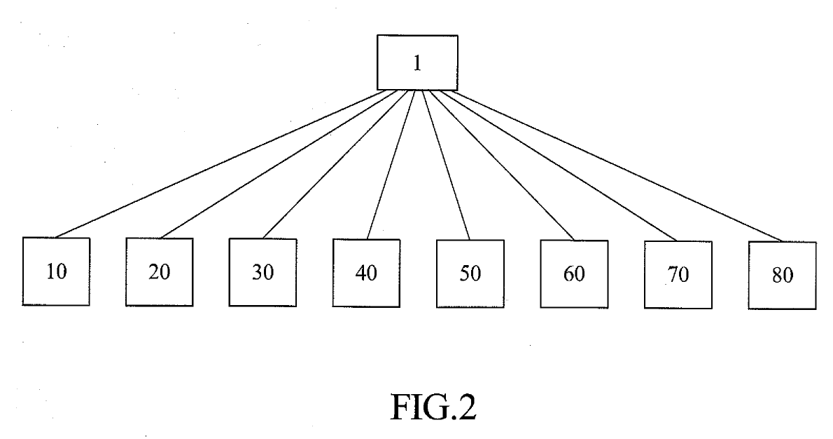

Referring to FIGS. 1 and 2, a material for manufacturing an environment friendly outsole 1 in accordance with a preferred embodiment of the invention comprises a first composition 10 of TPE (thermoplastic elastomer), a second composition 20 of silica, a third composition 30 of talcum powder, a fourth composition 40 of white oil, a fifth composition 50 of PS (polystyrene), a sixth composition 60 of HDPE (high density polyethylene), a seventh composition 70 of rice chaff powder, and an eighth composition 80 of SEBS (styrene ethylene butene styrene). Each of above components will now be described in detail below.

The first composition 10 of TPE is 35 (weight percentage) wt % to 45 wt % of the outsole 1. The second composition 20 of silica is 1 wt % to 10 wt % of the outsole 1. The third composition 30 of talcum powder is 0.1 wt % to 1 wt % of the outsole 1. The fourth composition 40 of white oil is 15 wt % to 40 wt % of the outsole 1. The fifth composition 50 of PS is 1 wt % to 10 wt % of the outsole 1. The sixth composition 60 of HDPE is 1 wt % to 10 wt % of the outsole 1. The seventh composition 70 of rice chaff powder is 10 wt % to 30 wt % of the outsole 1. The eighth composition 80 of SEBS is 1 wt % to 10 wt % of the outsole 1.

The outsole 1 made from the material thus has the advantages of reducing carbon emission, reducing the consumption of petroleum and plastics, and being light in weight due to the composition of rice chaff powder.

Preferably, the first composition 10 of TPE, the second composition 20 of silica, the third composition 30 of talcum powder, the fourth composition 40 of white oil, the fifth composition 50 of PS, the sixth composition 60 of HDPE, and the eighth composition 80 of SEBS are uniformly mixed by a mixer at a first temperature for a first period of time. Next, the mixture is further mixed with the seventh composition 70 of rice chaff powder. Next, the mixture is conveyed to an injection molding machine to heat at a second temperature. Finally, an outsole is produced.

Preferably, the first temperature is about 100° C.

Preferably, the first period of time is about 600 seconds.

Preferably, the second temperature is between 150° C. to 160° C.

The first composition 10 of TPE is the main composition of the outsole 1 and is comprised of about 60% of butene and about 40% of styrene. The second composition 20 of silica functions to make the outsole 1 more wear resistant. The third composition 30 of talcum powder functions to increase flow of the mixed material in the manufacturing process. The fourth composition 40 of white oil functions to increase or decrease the hardness of the outsole 1. In detail, the higher of the composition percentage of white oil the softer of the outsole 1 is. The fifth composition 50 of PS functions to increase or decrease the stiffness of the outsole 1. In detail, a high heel sole has a higher composition percentage of PS in order to increase the structural strength of the outsole 1. The provision of the sixth composition 60 of HDPE can reduce shoe weight. The provision of the eighth composition 70 of rice chaff powder can not only reduce shoe weight but also reduce the consumption of petroleum and plastics (i.e., reducing carbon emission). The eighth composition 80 of SEBS functions to increase the structural strength of the outsole 1. The eighth composition 80 of SEBS is comprised of about 68% of butene (or piperylene) and about 32% of styrene.

A manufacturing process of the outsole 1 comprises the steps of mixing all of the above compositions except the rice chaff powder in a mixer at about 150 for about 600 seconds wherein the screw-type beaters of the mixer are adapted to uniformly mix the compositions; pouring rice chaff powder (or potato powder, corn powder, wheat flour, or other biodegradable plant powder) into the mixture for further mixing at about 100° C. for about 60 seconds until the mixture is in a molten state; and conveying the molten mixture to an injection molding machine to heat at a temperature between 150° C. to 160° C.; and cooling the mold to produce an outsole 1.

The invention has the following advantages. The provision of the compositions of rice chaff powder and other non-plastic materials can not only reduce shoe weight but also reduce the consumption of petroleum and plastics (i.e., reducing carbon emission). Further, the produced outsoles are structurally strong and highly resistant to wear (i.e., durable). People treat rice chaff as waste. Hence, rice chaff is typically discarded or burned. This is not environment friendly because it may pollute environment. Advantageously, it is envisaged by the invention that rice chaff is pulverized to nanometer grade. Hence, the produced outsoles are environment friendly.

While the invention herein disclosed has been described by means of specific embodiments, numerous modifications and variations could be made thereto by those skilled in the art without departing from the scope and spirit of the invention set forth in the claims.

What is claimed is:

1. A material for manufacturing environment friendly outsoles comprising:
a first composition of TPE being 35 wt % to 45 wt % of a single one of the outsoles;
a second composition of silica being 1 wt % to 10 wt % of the single one of the outsoles;
a third composition of talcum powder being 0.1 wt % to 1 wt % of the single one of the outsoles;
a fourth composition of white oil being 15 wt % to 40 wt % of the single one of the outsoles;
a fifth composition of PS being 1 wt % to 10 wt % of the single one of the outsoles;
a sixth composition of HDPE being 1 wt % to 10 wt % of the single one of the outsoles,
a seventh composition of rice chaff powder being 10 wt % to 30 wt % of the single one of the outsoles; and
an eighth composition of SEBS being 1 wt % to 10 wt % of the single one of the outsoles.

2. The material of claim 1, wherein the first composition of TPE, the second composition of silica, the third composition of talcum powder, the fourth composition of white oil, the fifth composition of PS, the sixth composition of HDPE, and the eighth composition of SEBS are mixed in a mixer at a first temperature for a first period of time; the seventh composition of rice chaff powder is poured into the mixture for further mixing at a second temperature until the mixture is in a molten state; and the molten mixture is conveyed to an injection molding machine for producing the outsoles.

3. The material of claim 2, wherein the first temperature is 100° C.

4. The material of claim 2, wherein the first period of time is 600 seconds.

5. The material of claim 2, wherein the second temperature is between 150° C. to 160° C.
